(19) United States
(12) Patent Application Publication
(10) Pub. No.: US 2026/0260286 A1
(43) Pub. Date: Sep. 3, 2026

(54) USING GENERATIVE ARTIFICIAL INTELLIGENCE MODELS TO IMPLEMENT VOICE-POWERED SEARCH ENGINE

(71) Applicant: Maplebear Inc., San Francisco, CA (US)

(72) Inventors: Riddhima Sejpal, Dublin, CA (US); Naval Shah, Toronto (CA); Jatin Jain, Issaquah, WA (US)

(21) Appl. No.: 19/067,267

(22) Filed: Feb. 28, 2025

(51) Int. Cl. G06Q 30/0601; G06F 3/16

(52) U.S. Cl. CPC G06Q 30/0641; G06F 3/167; G06Q 30/0627; G06Q 30/0633

(57) ABSTRACT

An online system uses generative artificial intelligence models to implement a voice-powered search engine. Upon receiving and processing a user's input command, the online system prompts a generative model to derive a user's intent in the form of a set of structures fields, where each structured field is associated with a corresponding search type. After that, the online system prompt a set of generative models to extract entities (or values), where each entity populates a corresponding structured field and is related to a corresponding search type. The online system then maps the set of structures fields and the extracted entities into a search query, which is used to identify, from an item database, a list of items. The online system generates, using information about the list of items, a user interface signal causing a user's device to display a user interface with the list of items for user's conversion.

### BACKGROUND

Computing systems allow users to search for items via a search interface. Based on search terms provided by a user of an online system, for example, a search engine of the online system responds by presenting a set of items to the user as search results. Typically, search engines of online systems are capable of performing searches for items using voice commands or other free-text queries from their users. To improve an item search and make the item search more personalized, it is desirable for an online system to be able to interpret an intent of a user from a user's voice command or textual command. However, interpreting a user's intent from a voice command or textual command is a difficult task.

Therefore, there is a technical problem of how to infer the user's intent from a voice command or textual command, and then how to use the inferred user's intent to improve and personalize a search for items at an online system.

### SUMMARY

Embodiments of the present disclosure are directed to using generative artificial intelligence models (e.g., language models or machine-learning models) to implement a voice-powered search engine for an online system.

In accordance with one or more aspects of the disclosure, the online system receives, via a network and from a device associated with a user of the online system, an input command. The online system processes the input command to generate a processed version of the input command in a textual form. The online system generates a first prompt for input into a generative model (e.g., generative artificial intelligence model), the first prompt including the processed version of the input command and a request for generating a first response including a set of structured fields that are associated with an intent of the user derived from the input command. The online system requests the generative model to generate, based on the first prompt, the first response including the set of structured fields, each structured field of the set of structured fields associated with a respective search type of a set of search types. The online system generates a second prompt for input into a set of one or more generative models (e.g., one or more generative artificial intelligence models), the second prompt including the processed version of the input command, the first response, information about the user, information about a catalog of items, and a request for generating a second response including a respective value from a set of values for each structured field from the set of structured fields. The online system requests the set of one or more generative models to generate, based on the second prompt, the second response including the set of values for the set of structured fields. The online system maps the set of values for the set of structured fields into a search query having the set of structured fields. The online system identifies, using the search query and from a database of the online system, a list of one or more items. The online system generates, using information about the list of one or more items, a user interface signal. The online system sends, via the network, the user interface signal to the device associated with the user, wherein the sending the user interface signal causes the device associated with the user to display a user interface with the list of one or more items and one or more user interface elements for use by the user to add each item from the list of one or more items to an order.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example architectural flow diagram of using generative models (e.g., language models) to implement a voice-powered search engine for an online system, in accordance with one or more embodiments.

FIG. 4 is a flowchart for a method of using generative models (e.g., language models) to implement a voice-powered search engine for an online system, in accordance with one or more embodiments.

### DETAILED DESCRIPTION

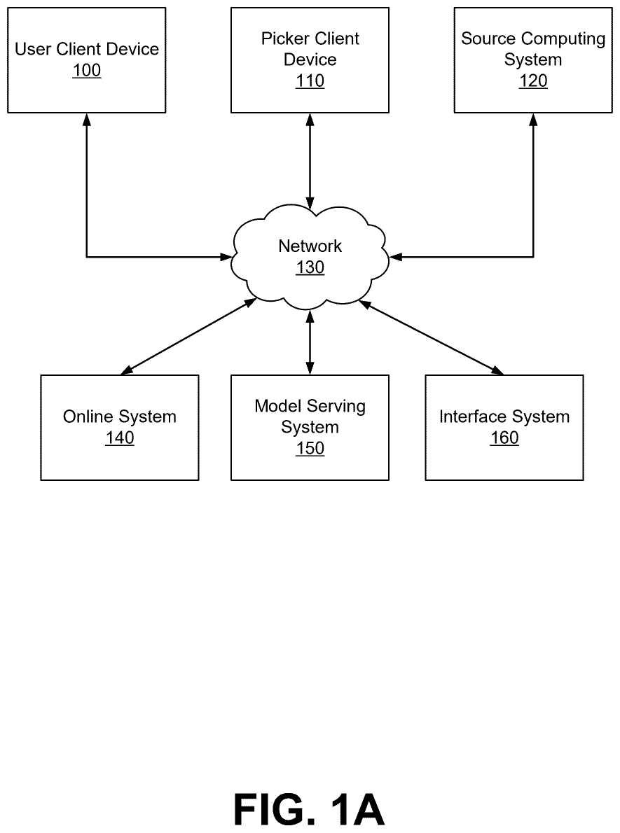

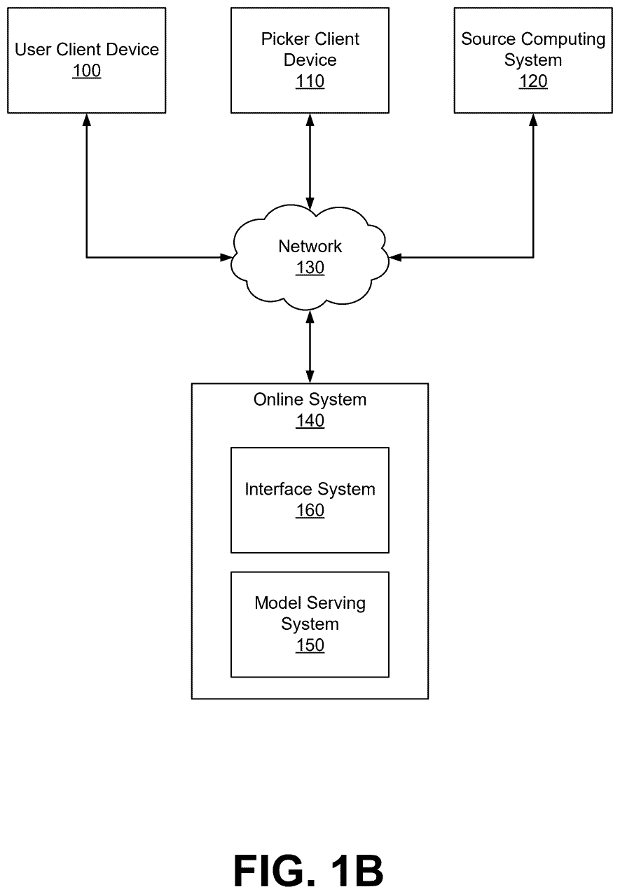

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 provides a search engine to enable users to search for items. The search engine of the online system may include an interface that can receive complex user inputs in the form of free texts or voice commands. To provide search results that respond to a user's intent in relation to a user's input, the online system 140 prompts an intent recognition generative model (e.g., language model) with the user's input and a request to extract one or more search types from the user's input, where each extracted search type relates to a type of constraint on the search. After that, the online system 140 prompts a set of entity extraction generative models (e.g., set of language models) with the user input, the extracted search types, and a request to identify entities (i.e., values) associated with each search type. Finally, the online system 140 executes a search (e.g., using another generative model or language model with access to a set of one or more search application programming interfaces (APIs)) using the extracted search types and entities (or values) as constraints of the search. The online system 140 then presents the search results to the user via a user interface of the user client device 100.

The online system 140 presented herein may thus combine the user's voice input with other inputs to improve the interpretation of the user's intent. The other inputs (in addition to the voice input) may be obtained using one or more APIs to obtain information about items. Furthermore, the online system 140 utilizes one or more generative models to interpret the type of search.

The online system 140 may communicate, via one or more APIs, with various third-party entities that allow the use of voice assistant devices, some of which include a screen for viewing actions and checking user interface changes, while other devices are entirely voice-operated without a user interface. The key challenge that the online system 140 presented herein aims to address is interpreting users' item search intents via voice commands and translating them into the item search API request flow using generative models (e.g., generative artificial intelligence models, or language models).

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

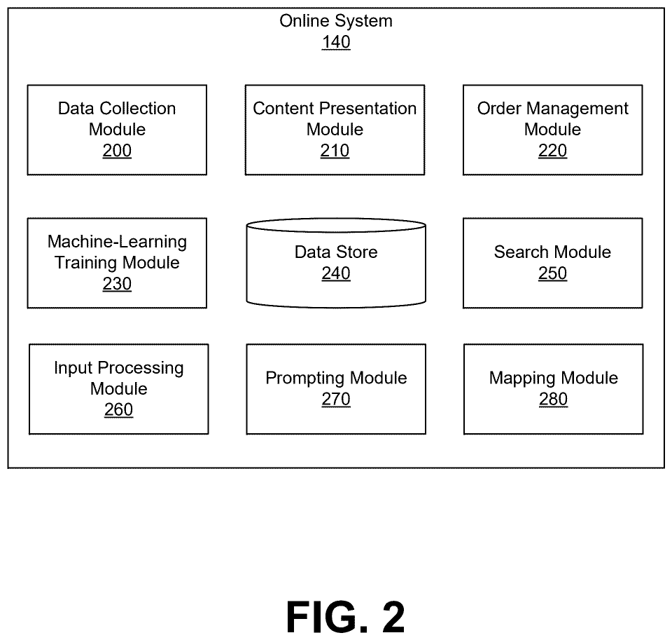

The online system 140 may employ an LLM of the model serving system 150 to parse a user's input (e.g., voice input) to interpret the user's intent in relation to the user's input. The online system 140 may prepare (e.g., via a prompting module 270 in FIG. 2) a prompt for input to the LLM. The prompt may include the user's input and a request to derive the user's intent from the user's input in the form of search types. The LLM may generate a response to the prompt based on execution of the machine-learning model using the prompt. The response may include information about the user's inferred intent, i.e., the derived search types. The online system 140 may import the response from the model serving system 150 and use the response as an input signal to a set of one or more LLMs of the model serving system 150 for extracting search entities (or values) in relation to the search types.

Thus, the online system 140 may further employ the set of LLMs of the model serving system 150 to extract search entities of different search types for constructing a complete search query. Each LLM from the set of LLMs may be tuned to extract a search entity of a specific search type. The online system 140 may prepare (e.g., via the prompting module 270) a second prompt for input to the set of LLMs. The second prompt may include the original user's input and the information about the user's intent previously inferred by the LLM, i.e., the extracted search types. The set of LLMs may generate a second response to the second prompt based on execution of the machine-learning model using the second prompt. The second response may include the extracted search entities of different search types. The online system 140 may import the second response from the model serving system 150 and use the second response as an input signal to construct the search query, e.g., by invoking a search API.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a search module 250, an input processing module 260, a prompting module 270, and a mapping module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The search module 250 may receive search queries (or search terms) via one or more application programing interfaces (APIs) of the online system 140. The search module 250 may include a search engine that conducts a search of an item catalog database (e.g., stored at the data store 240) based on the search queries. An API of the online system 140 may accept a “search term” or “search query” for an item or an ingredient in a recipe. Additionally, the API may offer configurable options to fine-tune the search based on the specific use case desired by users of the online system 140.

Given a search query received by the search module 250, the search module 250 may retrieve, via the API, a list of item identifiers. The search query may be used for both item searches initiated by the user or for finding a specific item identifier based on a name of an ingredient in a recipe. As part of the search query, the search module 250 may also receive information about one or more types of searches associated with the search query.

The API specification for a search conducted by the search module 250 can be defined as in Tables I through V provided below. By taking the item search API as an input, the voice-powered search is supported at the online system 140.

TABLE I
Search Request

| Name | In | Type | Required | Description |
|---|---|---|---|---|
| query | Body | String | Yes | The URL encoded search query |
| shop_id | Body | String | Yes | ShopID |
| limit | Body | Integer | No | Defaults to 10 |
| search_config | Body | SearchConfig | No | Different search configurations can be |
| | | | | supported based on the use case. |

TABLE II
Search Configuration

| Name | Type | Required | Description |
|---|---|---|---|
| search_type | String | Yes | Available values for search_type parameter |
| | | | “exact/substitute/regular”. |
| | | | Exact search: High relevance search where an item is |
| | | | not returned if the exact requested item is not available. |
| | | | For example, “lime” will not return “lemon”. |
| | | | Substitute: This search_type expands the search and |
| | | | drops relevance to include the exact plus its possible |
| | | | substitute if the exact is not available. For example, |
| | | | returning “lemon” when “lime” is not available. |
| | | | Regular: This search_type is a very generic search and |
| | | | expands its criteria more to include complimentary items |
| | | | with it. |
| search_ranking | String | No | Available values for search_type parameter |
| | | | “regular/relevance” |
| | | | Regular search: Makes sure ranking is based on |
| | | | personalization and other relevance signals but ranking |
| | | | users previously bought product on top. |
| | | | Relevance search: Make sure it prioritizes relevance |
| | | | ranking and might not be able to pull But-It-Again |
| | | | (BIA) item on top. |
| search_filters | Filter | No | Search Filters. More details in Table III. |

TABLE III
Search Filters

| Name | Type | Required | Description |
|---|---|---|---|
| brand_filters | Array(String) | No | Optional brand filters to match items. |
| | | | Add the brand names to the |
| | | | “brand_filters” array separated by |
| | | | commas. The brand filter is case- |
| | | | sensitive. Brand names must be spelled |
| | | | exactly as they appear in the catalog |
| | | | database. |
| health_filters | Array(String) | No | Optional health filters to match items. |
| | | | Valid values are ORGANIC, |
| | | | GLUTEN_FREE, FAT_FREE, VEGAN, |
| | | | KOSHER, SUGAR_FREE, LOW_FAT. |
| previously_purchased | Boolean | No | Optional filter to only return previously |
| | | | purchased items. (BIA filter). |

TABLE IV
Search Response

| Name | Type | Required | Description |
|---|---|---|---|
| items | Array(Items) | Yes | Search results |
| search_id | String | Yes | Search request ID for |
| | | | observability |
| search_url | String | Yes | URL to land on search page |

TABLE V
Item Object

| Name | Type | Required | Description |
|---|---|---|---|
| item_id | String | Yes | Internal reference of item |
| name | String | Yes | Product name |
| image_url | String | Yes | Link to image |

The input processing module 260 may receive and process an input from a user of the online system 140. The user may provide the input in the form of a voice command or as a free text input. In the case of the voice command, the input processing module 260 may perform the voice input processing by performing the speech-to-text extraction (or speech-to-text conversion). The input processing module 260 may utilize a speech-to-text (STT) service to transcribe the user's spoken queries. Examples of the spoken queries can be: (1) “Find olive oil for my pasta recipe.”; (2) “Find me muffins without milk products.”; (3) “Find me organic brand milk.”; and (4) “Find me my previously bought apples.”

In one or more embodiments, the prompting module 270 generates a prompt for input into a generative model (e.g., language model or LLM of the model serving system 150), where the prompt includes the user's input processed by the input processing module 260. The prompting module 270 may prompt the generative model to parse the user's input and interpret the user's intent, i.e., to perform the intent recognition or the intent derivation. In this manner, the prompting module 270 may generate a classification request for the generative model, where the generative model is being asked to extract, from the user's input, each of the structured fields defined in Tables I through V, i.e., to extract corresponding search types.

Hence, the online system 140 may utilize the generative model to understand and derive the user's intent from the transcribed text (e.g., as obtained via the input processing module 260). The prompting module 270 may also request the generative model to generate an output of a specific format. The output of the generative model may be a set of structured data in the requested format (e.g., a JavaScript Object Notation (JSON) file) with predetermined fields, where each field is associated with a specific search type.

Some examples of the user's intent recognized by the generative model are the following. For the example voice input “Find olive oil for my pasta recipe”, the generative model may recognize the user's intent as “search for a key ingredient”. For the example voice input “Find me muffins without milk product”, the generative model may interpret the user's intent as “requiring dairy-free or vegan muffins”. For the example voice input “Find me organic brand milk”, the generative model may identify the user's intent as “search for a specific branded item”. And for the example voice input “Find me my previous bought apples”, the generative model may identify the user's intent as “search for previously bought apples”.

In one or more embodiments, the prompting module 270 generates a prompt for input into a set of generative models (e.g., set of language models, or set of LLMs of the model serving system 150), where the prompt includes the output of the intent recognition generative model and a request for entity extraction, i.e., extraction of search entities or values associated with search types extracted by the intent recognition generative model. Each generative model from the set of generative models may be specifically tuned for a type of data being searched (e.g., brands, items with specific attributes, past purchases, etc.). At the entity extraction stage, the prompting module 270 may invoke the right generative model from the set of generative models (i.e., the generative model used for a specific search type, such as brand), and provides the original user's input along with the request to find a search entity (e.g., value that identifies a specific brand). An output of the entity extraction stage is, for each of the extracted structured data about the search intent, actual values that are redeleted in corresponding structured fields (e.g., brand=“Brand X”, attribute=“dairy free”, filter=“previously bought”, etc.).

To generate the prompt for input into the set of generative models for performing the entity extraction, the prompting module 270 may retrieve data from an item catalog database (e.g., stored at the data store 240), user profile information, and information about the user's purchase history. The online system 140 may leverage the set of generative models to extract search entities by interpreting the user's input (e.g., as converted to the text by the input processing module 260) in relation to both item catalog data and user profile information. The item catalog database may provide detailed information about item attributes, while the user profile offers information about personalized preferences, such as dietary restrictions and/or previous purchasing habits. Additionally, the set of generative models may utilize information about the user's purchase history for performing the entity extraction.

The set of generative models may thus process item catalog data and user data within the generative model context (or language model context), extract key search entities, and construct a complete search query. The integration of the item catalog data and the user data may refine the recognition of search terms, relevant filters, and configurations to align with both explicit user requests and implicit preferences, fostering accurate and personalized search outcomes.

In one or more embodiments, the set of entity extraction generative models are continuously retuned using feedback signals. The feedback signals are generated over time with information about usage data, changes in the item catalog database, and/or adjustments of user preferences. Based on the feedback signals, parameters of the set of entity extraction generative models are continuously updated.

Some examples of the entity extraction performed by the set of generative models are the following. For the example voice input “Find olive oil for my pasta recipe”, the set of generative models may extract “olive oil” with the search context being “recipe”. As the search context is “recipe”, then the “search_type” configuration should be “relevance”. For the example voice input “Find me muffins without milk product”, the set of generative models may extract “muffins” as a search term and infer the filter “vegan” based on the phrase “without milk” and available filters supported by the online system 140.

For the example voice input “Find me organic brand milk”, the set of generative models may extract “milk” as a search term and recognize an organic brand from the item catalog database. For the example voice input “Find me my previous bought apples”, the set of generative models may extract “apples” as a search term and from the user's purchase history obtain the information about the user's previous item selection. For example, if the user's previous item selection was “organic Brand A apple”, then the search entity is updated accordingly for search as being “Brand A apple”.

In one or more embodiments, the mapping module 280 maps information about the search entities extracted by the set of generative models to a search API. The mapping module 280 may invoke the search API using the information extracted at the entity extraction stage. In one or more embodiments, the mapping module 280 may prompt a generative model (or language model, such as an LLM of the model serving system 150) to construct a search query. In one or more other embodiments, the mapping module 280 may apply a corresponding algorithm to construct a search query. When performing the search query construction, the mapping module 280 may develop API search queries that capture the extracted search entities and search filters.

Some examples of the constructed search queries are the following. For the example voice input “Find olive oil for my pasta recipe”, the constructed search query (or search API) is:

```
{
  query_term: “olive oil”,
  search_config: {
    search_type: “relevance”,
    search_sorting: “relevance”
  }
}
```

For the example voice input “Find me muffins without milk product”, the constructed search query (or search API) is:

```
}
  query_term: “muffins”,
  search_config: {
    filters : {
      health_filters: [“vegan”]
      },
    search_type: “regular”,
    search_sorting: “regular”
  }
}
```

For the example voice input “Find me organic brand milk”, the constructed search query (or search API) is:

```
  {
  query_term: “milk”,
    search_config: {
      filters : {
        brand_filters: [“Organic brand”]
        },
      search_type: “regular”,
      search_sorting: “regular”
    }
}
```

For the example voice input “Find me my previous bought apples”, the constructed search query (or search API) is:

```
{
query_term: “Brand A apples”,
  search_config: {
    filters : {
      health_filters: [“organic”],
        previously_purchased: “true”
      },
    search_type: “regular”,
    search_sorting: “regular”
  }
}
```

Some additional examples of constructed search queries are the following. For the example voice command “Find me gluten-free bread for sandwiches”, the constructed search query (or search API) is:

```
{
      search_term: “bread”,
  search_config: {
    filters: {
        health_filters: [“gluten-free”]
      }
    search_type: “regular”,
    search_sorting: “regular”
  }
}
```

For the example voice command: “Find me the cheapest detergent for laundry”, the constructed search query (or search API) is:

```
{
      search_term: “detergent”,
  search_config: {
    search_type: “regular”,
    search_sorting: “price”
  }
}
```

For the example voice command: “Find Brand B body wash suitable for dry skin”, the constructed search query (or search API) is:

```
{
      search_term: “body wash”,
  search_config: {
    filters: {
        brand_filters: [“Brand B”]
      }
    search_type: “regular”,
    search_sorting: “regular”
  }
}
```

For the example voice command: “Reorder the coffee beans I bought last month”, the constructed search query (or search API) is:

```
{
      search_term: “coffee beans”,
  search_config: {
    filters: {
        previously_purchased: true
      }
    search_type: “regular”,
    search_sorting: “regular”
  }
}
```

Additional use cases can be handled by adding more filters into search APIs, such as “Electronic Benefit Transfer (EBT)”, “on sale”, or by adding sorting by “price high to low”/“price low to high”. Hence, based on the user's command, additional search types and search context can be inferred, as well as more item categories.

The search module 250 may identify, using the constructed search query, a list of one or more items from the item catalog database (e.g., the data store 240). To identify the list of one or more items, the search module 250 may conduct a search of the item catalog database using, as constraints of the search, the set of search types derived during the intent recognition stage and values (or search entities) obtained during the entity extraction stage.

The content presentation module 210 may generate, using information about the list of one or more items, a user interface signal. The content presentation module 210 may send, via the network 130, the user interface signal to the user client device 100 causing the user client device 100 to display a user interface with the list of one or more items and one or more user interface elements for use by the user to add each item from the list of one or more items to a current order.

The online system 140 employing the generative models as presented herein can support voice assistant devices for performing searches using third-party endpoints. Additionally, by employing the generative models, the online system 140 can support adding voice features for searching the item catalog database of the online system 140 by employing an internal search API. Furthermore, the online system 140 employing the generative models may allow for supporting a care bot, i.e., an artificial intelligence agent that helps people searching items at the online system 140 using voice.

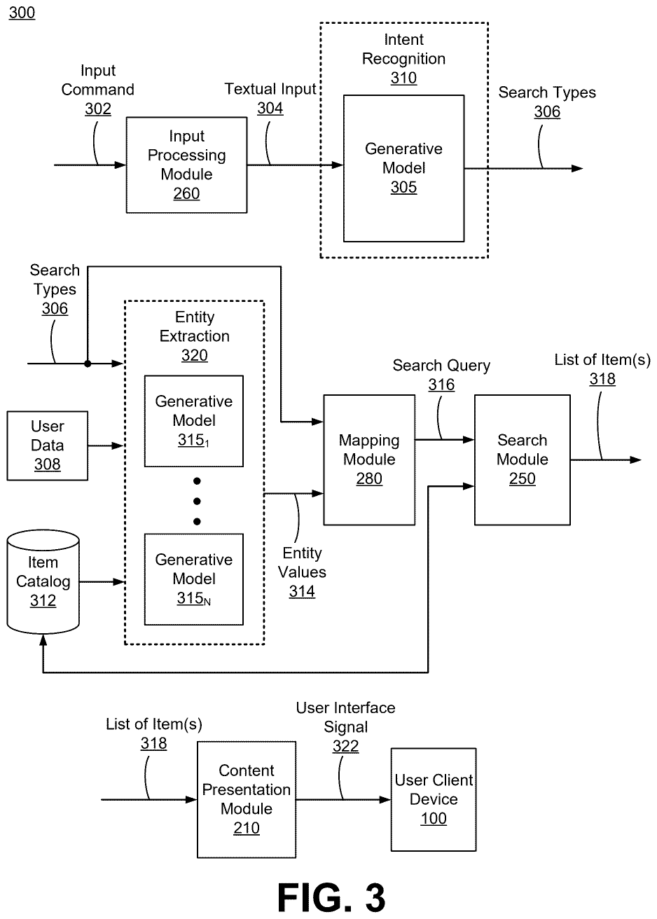

FIG. 3 illustrates an example architectural flow diagram 300 of using generative models to implement a voice-powered search engine for the online system 140, in accordance with one or more embodiments. A search process is initiated when the input processing module 260 receives, via the network 130 and from the user client device 100, an input command 302 (e.g., voice command or free text) provided by a user of the online system 140 via a user interface of the user client device 100. The input processing module 260 may then process the input command 302 to generate a textual input 304. When the input command 302 is a voice command, the input processing module 260 may perform the speech-to-text conversion of the input command 302. When the input command 302 is a free text entered by the user via the user interface, the input processing module 260 may parse the free text (e.g., correct for typos and place the free text in a defined format) to generate the textual input 304.

The prompting module 270 may include the textual input 304 into a prompt for input into a generative model 305 (e.g., language model or LLM). The generative model 305 may form an intent recognition stage 310 of the search process. The generative model 305 may use the textual input 304 to extract search types 306 that define the user's intent in relation to the input command 302. The search types 306 extracted by the generative model 305 may be in the form of a set of structured fields, e.g., as defined by a search API of the online system 140.

The prompting module 270 may include the search types 306 along with user data 308 and item data retrieved from item catalog 312 into a prompt for input into a set of generative models 3151, . . . , 315N, N≥1, (e.g., set of language models, or set of LLMs). The user data 308 may include information about past conversions of the user, information about dietary preferences for the user, some other user related data retrieved from a user catalog database (e.g., stored at the data store 240), or some combination thereof. The prompting module 270 may retrieve the item data from the item catalog 312 using the textual input 304. The set of generative models 3151, . . . , 315N may form an entity extraction stage 320 of the search process. The set of generative models 3151, . . . , 315N may use the search types 306, the user data 308 and the item data from the item catalog 312 to generate entity values 314, where each entity value 314 is a value that identifies a corresponding search type 306. In other words, each entity value 314 is a specific value of a corresponding structured field of the set of structured fields defined by the search API. The extracted entity values 314 along with the search types 306 may be passed to the mapping module 280.

The mapping module 280 may map the entity values 314 and the search types 306 into a search query 316 that is constructed to have the set of structured fields defined by the search types 306 populated by the entity values 314. To construct the search query 316, the mapping module 280 may invoke the search API using the entity values 314 for the set of structured fields defined by the search types 306. The mapping module 280 may pass the search query 316 to the search module 250.

The search module 250 may use the search query 316 to identify, from the item catalog 312, a list of one or more items 318. To identify the list of one or more items 318, the search module 250 may conduct a search of the item catalog 312 using, as constraints of the search, the search types 306 and the entity values 314 within the search query 316. The search module 250 may pass the identified list of one or more items 318 to the content presentation module 210.

The content presentation module 210 may generate, using information about the list of one or more items 318, a user interface signal 322. The content presentation module 210 may send, via the network 130, the user interface signal 322 to the user client device 100 causing the user client device 100 to display a user interface with the list of one or more items 318 and one or more user interface elements for use by the user to add each item from the list of one or more items 318 to a current order.

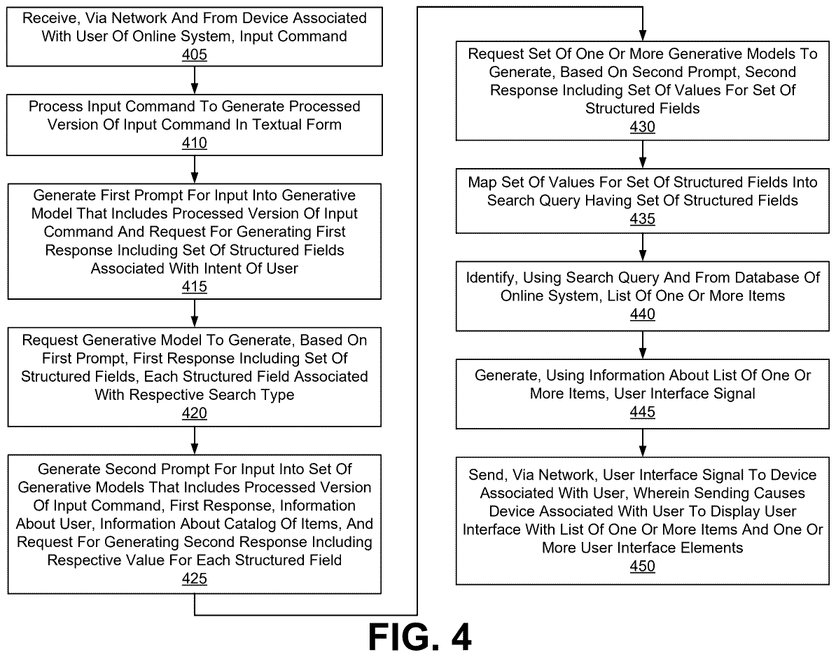

FIG. 4 is a flowchart for a method of using generative models to implement a voice-powered search engine for an online system, in accordance with one or more embodiments, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the input processing module 260), via a network (e.g., the network 130) and from a device associated with a user of the online system 140 (e.g., the user client device 100), an input command. The online system 140 processes 410 (e.g., via the input processing module 260) the input command to generate a processed version of the input command in a textual form.

The online system 140 may receive the input command by receiving (e.g., at the input processing module 260) a voice input from the user. The online system 140 may process the input command by converting (e.g., via the input processing module 260) the voice input into the processed version of the input command that includes voice content in the textual form. Alternatively, the online system 140 may receive (e.g., at the input processing module 260), via the network, a free text input entered (e.g., by the user) via the user interface of the device associated with the user.

The online system 140 generates 415 (e.g., via the prompting module 270) a first prompt for input into a generative model (e.g., language model or LLM), the first prompt including the processed version of the input command and a request for generating a first response including a set of structured fields that are associated with an intent of the user derived from the input command. The online system 140 requests 420 (e.g., via the prompting module 270) the generative model to generate, based on the first prompt input, the first response including the set of structured fields, each structured field of the set of structured fields associated with a respective search type of a set of search types.

The online system 140 may request (e.g., via the prompting module 270) the generative model to derive, using the first prompt, the intent of the user. The online system 140 may request (e.g., via the prompting module 270) the generative model to extract, from the processed version of the input command, each structured field in the set of structured fields that define the intent of the user.

The online system 140 generates 425 (e.g., via the prompting module 270) a second prompt for input into a set of one or more generative models (e.g., set of one or more language models, or set of one or more LLMs), the second prompt including the processed version of the input command, the first response, information about the user, information about a catalog of items, and a request for generating a second response including a respective value from a set of values for each structured field from the set of structured fields. The online system 140 requests 430 (e.g., via the prompting module 270) the set of one or more generative models to generate, based on the second prompt, the second response including the set of values for the set of structured fields.

The online system 140 may generate the second prompt by retrieving (e.g., via the prompting module 270), from a database of the online system 140 (e.g., the data store 240), information about the user including at least one of information about past conversions of the user or information about dietary preferences for the user. The online system 140 may request (e.g., via the prompting module 270) the set of one or more generative models to extract, using the second prompt, a set of entities in relation to the set of structured fields, the set of entities including the set of values defining at least one of one or more search terms, one or more filters, one or more attributes, or one or more item identifiers. The online system 140 may request (e.g., via the prompting module 270) each generative model from the set of one or more generative models to generate a respective value of the set of values for a respective structured field of the set of structured fields.

The online system 140 maps 435 (e.g., via the mapping module 280) the set of values for the set of structured fields into a search query having the set of structured fields. The online system 140 may invoke (e.g., via the mapping module 280), using the set of values for the set of structured fields, a search API to construct the search query. Alternatively, the online system 140 may generate (e.g., via the prompting module 270 or the mapping module 280) a third prompt for input into a second generative model (e.g., language model or LLM), the third prompt including the set of values for the set of structured fields and a request for generating a third response including the search query. In such cases, the online system 140 may request (e.g., via the prompting module 270 or the mapping module 280) the second generative model to generate, based on the third prompt, the third response including the search query.

The online system 140 identifies 440 (e.g., via the search module 250), using the search query and from a database of the online system 140 (e.g., the data store 240), a list of one or more items. The online system 140 may perform (e.g., via the search module 250) a search of the database using the set of search types and the set of values as constraints of the search.

The online system 140 generates 445 (e.g., via the content presentation module 210), using information about the list of one or more items, a user interface signal. The online system 140 sends 450 (e.g., via the content presentation module 210), via the network, the user interface signal to the device associated with the user, wherein the sending the user interface signal causes the device associated with the user to display a user interface with the list of one or more items and one or more user interface elements, and wherein selection of a corresponding one of the one or more user interface elements causes addition of a corresponding item from the list of one or more items to an order.

The online system 140 may retrieve (e.g., via the model serving system 150), from the database, catalog changes including information about changes in the database in relation to a set of items that occurred during a defined time period. The online system 140 may further retrieve (e.g., via the model serving system 150), from the database, user preference adjustments including information about changes in relation to conversion preferences for a set of users of the online system 140 that occurred during the defined time period. The online system 140 may generate (e.g., via the model serving system 150) tuning data including the catalog changes and the user preference adjustments. The online system 140 may retune (e.g., via the model serving system 150) the generative model and the set of one or more generative models using the tuning data.

The online system 140 may receive (e.g., at the model serving system 150), from the device associated with the user and via the network, user feedback data including information about engagement of the user with the list of one or more items. The online system 140 may retune (e.g., via the model serving system 150) the generative model and the set of one or more generative models using the user feedback data.

Embodiments of the present disclosure are directed to the online system 140 that uses generative models (e.g., language models or LLMs) to implement a voice-powered search engine for the online system 140. The search engine includes multiple stages of interpreting a user's input to provide search results, i.e., (1) extract search types (e.g., user's intents) from a free text; (2) extract entities (i.e., values) associated with each search type; and (3) run search using the extracted search types and values as constraints of the search. The extraction of search types and entities associated with each search type may be performed by utilizing generative models.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from a device associated with a user of an online system, an input command;
processing the input command to generate a processed version of the input command in a textual form;
generating a first prompt for input into a generative model, the first prompt including the processed version of the input command and a request for generating a first response including a set of structured fields that are associated with an intent of the user derived from the input command;
requesting the generative model to generate, based on the first prompt, the first response including the set of structured fields, each structured field of the set of structured fields associated with a respective search type of a set of search types;
generating a second prompt for input into a set of one or more generative models, the second prompt including the processed version of the input command, the first response, information about the user, information about a catalog of items, and a request for generating a second response including a respective value from a set of values for each structured field from the set of structured fields;
requesting the set of one or more generative models to generate, based on the second prompt, the second response including the set of values for the set of structured fields;
mapping the set of values for the set of structured fields into a search query having the set of structured fields;
identifying, using the search query and from a database of the online system, a list of one or more items;
generating, using information about the list of one or more items, a user interface signal; and
sending, via the network, the user interface signal to the device associated with the user, wherein the sending the user interface signal causes the device associated with the user to display a user interface with the list of one or more items and one or more user interface elements, and wherein selection of a corresponding one of the one or more user interface elements causes addition of a corresponding item from the list of one or more items to an order.

2. The method of claim 1, wherein:
receiving the input command comprises receiving a voice input from the user; and
processing the input command comprises converting the voice input into the processed version of the input command that includes voice content in the textual form.

3. The method of claim 1, wherein receiving the input command comprises:
receiving, via the network, a free text input entered via the user interface of the device associated with the user.

4. The method of claim 1, wherein requesting the generative model to generate the first response comprises:
requesting the generative model to derive, using the first prompt, the intent of the user; and
requesting the generative model to extract, from the processed version of the input command, each structured field in the set of structured fields that define the intent of the user.

5. The method of claim 1, wherein generating the second prompt comprises:
retrieving, from the database, information about the user including at least one of information about past conversions of the user or information about dietary preferences for the user.

6. The method of claim 1, wherein requesting the set of one or more generative models to generate the second response comprises:
requesting the set of one or more generative models to extract, using the second prompt, a set of entities in relation to the set of structured fields, the set of entities including the set of values defining at least one of one or more search terms, one or more filters, one or more attributes, or one or more item identifiers.

7. The method of claim 1, wherein requesting the set of one or more generative models to generate the second response comprises:
requesting each generative model from the set of one or more generative models to generate a respective value of the set of values for a respective structured field of the set of structured fields.

8. The method of claim 1, wherein mapping the set of values into the search query comprises:
invoking, using the set of values for the set of structured fields, a search application programming interface (API) to construct the search query.

9. The method of claim 1, wherein mapping the set of values into the search query comprises:
generating a third prompt for input into a second generative model, the third prompt including the set of values for the set of structured fields and a request for generating a third response including the search query; and
requesting the second generative model to generate, based on the third prompt, the third response including the search query.

10. The method of claim 1, wherein identifying the list of one or more items comprises:
performing a search of the database using the set of search types and the set of values as constraints of the search.

11. The method of claim 1, further comprising:
retrieving, from the database, catalog changes including information about changes in the database in relation to a set of items that occurred during a defined time period;
retrieving, from the database, user preference adjustments including information about changes in relation to conversion preferences for a set of users of the online system that occurred during the defined time period;
generating tuning data including the catalog changes and the user preference adjustments; and
retuning the generative model and the set of one or more generative models using the tuning data.

12. The method of claim 1, further comprising:
receiving, from the device associated the user and via the network, user feedback data including information about engagement of the user with the list of one or more items; and
retuning the generative model and the set of one or more generative models using the user feedback data.

13. A computer program product comprising a non-transitory computer readable storage medium having instructions encoded thereon that, when executed by a processor, cause the processor to perform steps comprising:
receiving, via a network and from a device associated with a user of an online system, an input command;
processing the input command to generate a processed version of the input command in a textual form;
generating a first prompt for input into a generative model, the first prompt including the processed version of the input command and a request for generating a first response including a set of structured fields that are associated with an intent of the user derived from the input command;
requesting the generative model to generate, based on the first prompt, the first response including the set of structured fields, each structured field of the set of structured fields associated with a respective search type of a set of search types;
generating a second prompt for input into a set of one or more generative models, the second prompt including the processed version of the input command, the first response, information about the user, information about a catalog of items, and a request for generating a second response including a respective value from a set of values for each structured field from the set of structured fields;
requesting the set of one or more generative models to generate, based on the second prompt, the second response including the set of values for the set of structured fields;
mapping the set of values for the set of structured fields into a search query having the set of structured fields;
identifying, using the search query and from a database of the online system, a list of one or more items;
generating, using information about the list of one or more items, a user interface signal; and
sending, via the network, the user interface signal to the device associated with the user, wherein the sending the user interface signal causes the device associated with the user to display a user interface with the list of one or more items and one or more user interface elements, and wherein selection of a corresponding one of the one or more user interface elements causes addition of a corresponding item from the list of one or more items to an order.

14. The computer program product of claim 13, wherein the instructions further cause the processor to perform steps comprising:
receiving the input command by receiving a voice input from the user; and
processing the input command comprises by converting the voice input into the processed version of the input command that includes voice content in the textual form.

15. The computer program product of claim 13, wherein the instructions further cause the processor to perform steps comprising:
requesting the generative model to derive, using the first prompt, the intent of the user; and
requesting the generative model to extract, from the processed version of the input command, each structured field in the set of structured fields that define the intent of the user.

16. The computer program product of claim 13, wherein the instructions further cause the processor to perform steps comprising:
requesting the set of one or more generative models to extract, using the second prompt, a set of entities in relation to the set of structured fields, the set of entities including the set of values defining at least one of one or more search terms, one or more filters, one or more attributes, or one or more item identifiers.

17. The computer program product of claim 13, wherein the instructions further cause the processor to perform steps comprising:
invoking, using the set of values for the set of structured fields, a search application programming interface (API) to construct the search query.

18. The computer program product of claim 13, wherein the instructions further cause the processor to perform steps comprising:
identifying the list of one or more items by performing a search of the database using the set of search types and the set of values as constraints of the search.

19. The computer program product of claim 13, wherein the instructions further cause the processor to perform steps comprising:
retrieving, from the database, catalog changes including information about changes in the database in relation to a set of items that occurred during a defined time period;
retrieving, from the database, user preference adjustments including information about changes in relation to conversion preferences for a set of users of the online system that occurred during the defined time period;
generating tuning data including the catalog changes and the user preference adjustments; and
retuning the generative model and the set of one or more generative models using the tuning data.

20. A computer system comprising:
a processor; and
a non-transitory computer-readable storage medium having instructions that, when executed by the processor, cause the computer system to perform steps comprising:
receiving, via a network and from a device associated with a user of an online system, an input command;
processing the input command to generate a processed version of the input command in a textual form;
generating a first prompt for input into a generative model, the first prompt including the processed version of the input command and a request for generating a first response including a set of structured fields that are associated with an intent of the user derived from the input command;
requesting the generative model to generate, based on the first prompt, the first response including the set of structured fields, each structured field of the set of structured fields associated with a respective search type of a set of search types;
generating a second prompt for input into a set of one or more generative models, the second prompt including the processed version of the input command, the first response, information about the user, information about a catalog of items, and a request for generating a second response including a respective value from a set of values for each structured field from the set of structured fields;
requesting the set of one or more generative models to generate, based on the second prompt, the second response including the set of values for the set of structured fields;
mapping the set of values for the set of structured fields into a search query having the set of structured fields;
identifying, using the search query and from a database of the online system, a list of one or more items;
generating, using information about the list of one or more items, a user interface signal; and
sending, via the network, the user interface signal to the device associated with the user, wherein the sending the user interface signal causes the device associated with the user to display a user interface with the list of one or more items and one or more user interface elements, and wherein selection of a corresponding one of the one or more user interface elements causes addition of a corresponding item from the list of one or more items to an order.
